(19) United States
(12) Patent Application Publication
(10) Pub. No.: US 2005/0269757 A1
(43) Pub. Date: Dec. 8, 2005

(54) Reconfigurable clamp for a flexible manufacturing system

(76) Inventors: Robin Stevenson, Bloomfield, MI (US); Roland J. Menassa, Macomb, MI (US); Ivan G. Sears, Rochester Hills, MI (US)

Correspondence Address: General Motors Corporation, Legal Staff;Mail Code 482-CCS-B21, 300 Renaissance Center, P.O. Box 300, Detroit, MI, 48265, US

(21) Appl. No.: 11/144,262

(22) Filed: Jun. 3, 2005

Related U.S. Application Data
(60) Provisional application No. 60/577,104, filed on Jun. 4, 2004.

(51) Int. Cl. B25B 5/16

(52) U.S. Cl. 269/266

(57) ABSTRACT

A reconfigurable clamp for providing support for a variety of different body panel configurations employed in the vehicle assembly without requiring manual adjustment or reprogramming. The clamp includes an adjustable contact portion comprising a plurality of pins slidably engaged within sleeves formed in a body portion. The pins include a head portion and a shaft portion extending from the head portion, wherein the shaft portion has an engageable portion. The clamp further comprises a plurality of slidably mounted rods disposed generally transverse to the movement of the pins within the sleeves. The slidably mounted rods have a complementary engageable portion that lockingly engages the engageable portion of the shaft portion upon contact therewith to selectively prevent further movement of the pins within the sleeves, such as may be desired once a workpiece is loaded onto the clamp.

### CROSS REFERENCE TO RELATED APPLICATIONS

This application relates to, and claims priority to, provisional U.S. Application No. 60/577,104 filed on Jun. 4, 2004, hereby incorporated by reference in its entirety.

### BACKGROUND

The present disclosure generally relates to a flexible manufacturing system for vehicle assembly, and more particularly, to a reconfigurable clamp for providing support for a variety of different body panel configurations employed in the vehicle assembly without requiring manual adjustment or reprogramming.

The advent of assembly lines has enabled rapid, mass production of products at a reduced product cost. Assembly lines typically include multiple operation stages with component, material or sub-assembly inputs. Sometimes the workpieces are similar or related part shapes. Other times, the workpieces are of unrelated design but require similar manufacturing operations. In these varied applications, the fixture reconfiguration or changeover from one part design to another has to be fast enough to meet the productivity requirements of current manufacturing systems.

Previous efforts in designing and developing flexible fixturing for either small batch manufacture or mass production scenarios can generally include the use of modular fixtures and conformable fixtures. Modular fixturing generally includes fixtures assembled from a standard library of elements such as V-blocks, toggle clamps, locating blocks, and the like. Their flexibility lies in the ability to be reconfigured either manually or by a robotic device. However, modular fixtures have no intrinsic ability to adapt to different sizes and shapes of parts within a part family. In addition, the time necessary for reconfiguration is long and modular fixtures generally lack stiffness. As a result, modular fixtures are more suited to a job shop environment rather than mass production.

The advent of Flexible Manufacturing Systems (FMS) in the early 1960's provided the impetus for work on conformable fixturing. A conformable fixture is defined as one that can be configured to accept parts of varying shape and size. Conformable fixture technology generally includes encapsulant or mechanistic techniques. Examples of encapsulant fixtures are found in the aerospace industry, where low melting-point metals are used to enclose turbine blades and produce well-defined surfaces for part location and clamping for grinding operations. While an excellent means of facilitating the holding of complex parts, encapsulation is a costly and time-consuming process.

Mechanistic fixtures reported in the literature include the use of petal collets, programmable conformable clamps, a programmable/multi-leaf vise, an adjustable integral fixture pallet, and the like. Of these, the adjustable integral fixture pallet concept appears to be the most capable of accommodating a part family of castings. To date, however no feasibility studies have been conducted regarding the applicability of any of these techniques to production machining operations.

One troublesome area in flexible manufacturing systems is its implementation in body shops. Clamps are typically employed to support the various sheet metal workpieces, e.g., body panels, during assembly and clamping can potentially scratch the exposed surface and/or locally deform the workpiece, affecting its aesthetic quality. While, ideally, clamping could be performed on flanges or surfaces that are invisible or immaterial to end users, some clamping inevitably occurs on exposed surfaces.

Current clamps utilized in assembly lines generally include a clamp block, which accurately matches the contours of the workpiece and a matching pressure foot. In operation, the clamp block supports the exterior surface of the workpiece while the pressure foot contacts the inner (non-exposed) surface with a compliant pad shaped to approximate, in the unloaded condition, a point. With this approach, minor differences between the shape of the workpiece and the clamp block geometry can be accommodated without introducing local deformation. As a result, the contour of each clamp block is generally specific to a limited number of work pieces and surfaces. In dedicated facilities, the contours of the clamp block are generally fabricated by numerically controlled (NC) machining using data generated from the workpiece to be fixtured. A problem arises if multiple models are produced having significantly different workpiece configurations. Multiple clamp blocks having different contours are then required to accommodate the multiplicity of workpiece configurations.

Accordingly, there remains a need for a reconfigurable clamp block that can provide adequate support for a variety of workpiece configurations.

### BRIEF SUMMARY

Disclosed herein are reconfigurable clamps, clamp systems, and methods of operation. In one embodiment, a reconfigurable clamp comprises a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body; and a linear slide portion comprising a movable body and a rod extending from the movable body; wherein one end of the rod is slidably mounted in the opening and comprises a geometry complementary to the engageable portion.

In another embodiment, a reconfigurable clamp system comprises a support comprising a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body, and a linear slide portion comprising a movable body, and a rod extending from the movable body, wherein one end of the rod is slidably mounted in the opening and comprises a geometry complementary to the engageable portion; and a member in operative communication with the support.

A process for clamping a workpiece comprises loading a first workpiece onto a reconfigurable clamp, wherein the reconfigurable clamp comprises a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body, and a linear slide portion comprising a movable body, and a rod extending from the movable body, wherein one end of the rod is slidably mounted in the opening and comprises a geometry complementary to the engageable portion; compressing the pin to conform substantially to a surface contour of the first workpiece; moving the movable body in an amount and direction effective to advance the rod to lockingly engage the engageable portion; and applying a member to a backside of the first workpiece.

The above described and other features are exemplified by the following figures and detailed description.

### BRIEF DESCRIPTION OF THE DRAWINGS

Referring now to the figures, which are exemplary embodiments and wherein the like elements are numbered alike:

FIG. 1 is a cross sectional view of a reconfigurable clamp block;

FIG. 2 is top down view of the reconfigurable clamp block of FIG. 1;

FIGS. 3-7 schematically illustrate a slide locking reconfigurable clamp system at various stages of a process sequence employing the reconfigurable clamp.

### DETAILED DESCRIPTION

Disclosed herein are a reconfigurable clamp, reconfigurable clamp system, and process for providing support and securement of a variety of dissimilar workpieces. Although, reference will be made to its use in fixturing automotive body panels, it should be understood that the reconfigurable clamp, reconfigurable clamp system, and process could be employed for a variety of end use applications where it may be desirable to support dissimilar workpieces with the clamp without requiring manual adjustment or reprogramming or clamp replacement that is generally performed to accommodate the different configurations of workpieces. For example, the reconfigurable clamp system and the various components thereof can be employed in flexible manufacturing systems for thin walled and/or thick walled objects, contoured and/or planar objects, on exterior surfaces as well as hidden surfaces, and the like. Advantageously, the reconfigurable clamp system can be used on exposed surfaces of body panels without marring, scratching, and/or causing local deformations. The following description of preferred embodiments is merely exemplary in nature and is in no way intended to limit the disclosure, its application, or uses.

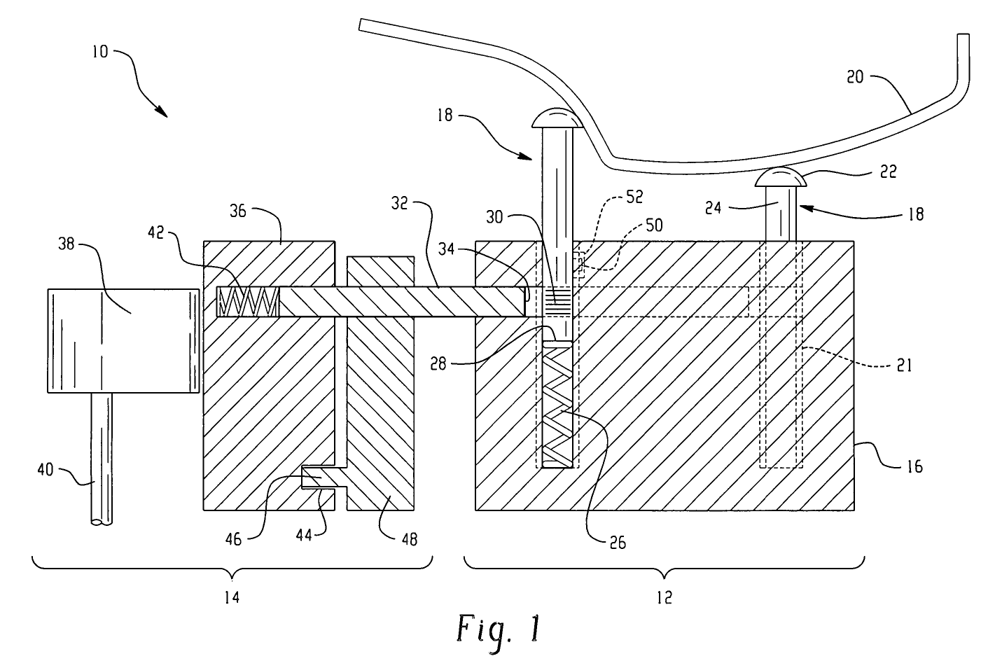

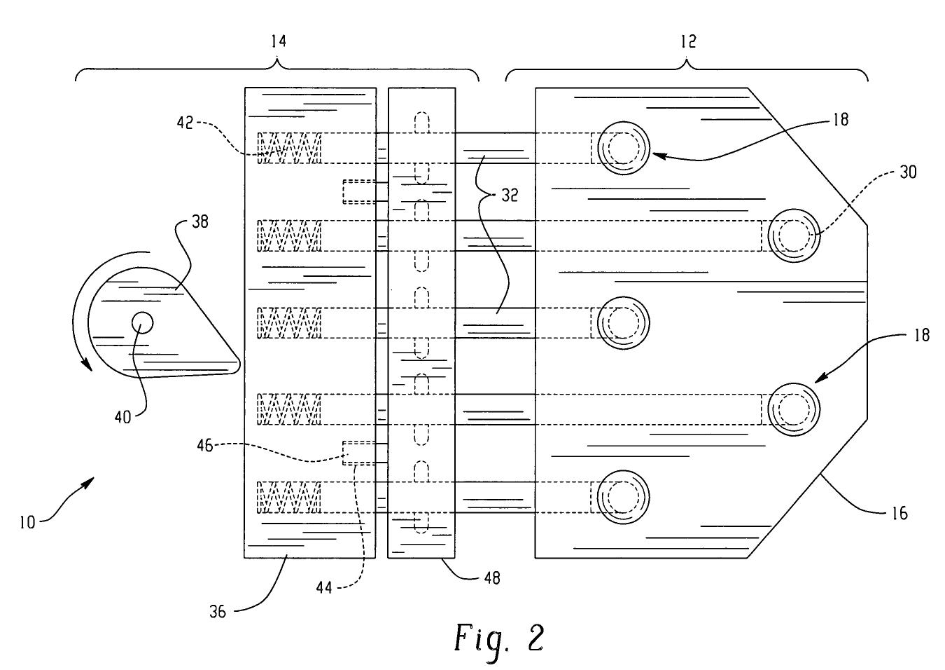

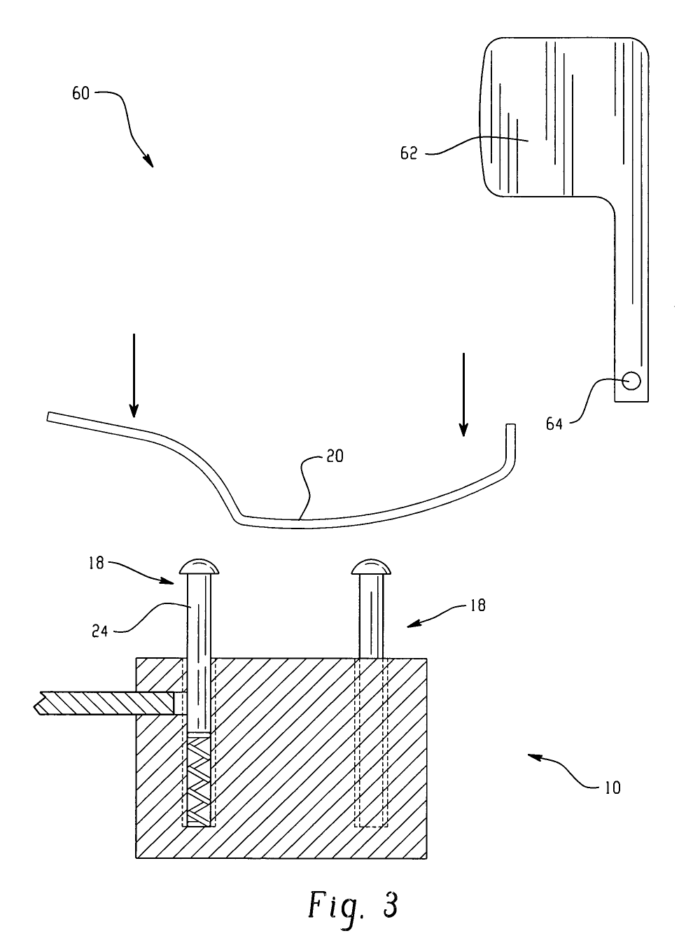

Referring now to FIGS. 1 and 2, there is shown an exemplary reconfigurable clamp, generally designated by reference numeral 10, which is suitable for use in the reconfigurable clamp system. As will be appreciated by those skilled in the art in view of this disclosure, the reconfigurable clamp and/or system is well suited for integration with flexible manufacturing systems. The reconfigurable clamp system generally includes a matching pressure foot (see FIGS. 3-7) for clamping workpieces 20 during manufacturing. Advantageously, the reconfigurable clamp and/or system can be employed to accommodate a variety of different product types. In this manner, significant savings can be obtained by reducing design, engineering, manufacturing, and purchasing of clamp blocks for each product type, e.g., dissimilar body panels.

The reconfigurable clamp 10 generally includes a reconfigurable contact portion 12 and a linear slide portion 14. The reconfigurable contact portion 12 and a linear slide portion 14 may be integrated into a single unitary component or may form distinct components that form the clamp 10. Advantageously, the reconfigurable clamp 10 eliminates the need for manual adjustment and reprogramming during changeovers.

The reconfigurable contact portion 12 comprises a body 16 and a plurality of spring-loaded pins 18 mounted within a body 16 for contacting workpiece 20. As will be discussed in greater detail below, the spring-loaded pins 18 can be vertically adjusted to a fixed height relative to the body 16 upon engagement of the linear slide portion 14. In this manner, upon loading a workpiece 20 onto the contact portion 12 the spring-loaded pins 18 can conform to a contoured surface thereof and subsequently be locked in the vertical position to provide a stable conformal support to the workpiece 20. As shown in FIG. 2, there are five spring-loaded pins 18. The disclosure is not intended to be limited to the five pins as shown. More or fewer pins can be employed depending on the desired application. Likewise, the spatial arrangement of the pins 18 within the body 16 is not intended to be limited and will generally depend on the configurations of the workpieces.

Each pin 18 is independently vertically adjustable within a cylindrically shaped sleeve 21 within the body 16. The sleeves 21 are dimensioned to permit movement of the pin 18 along the length of the sleeve 20, yet restrain or minimize lateral motion. Each pin 18 includes a head 22 and a shaft 24 extending from the head 18. A compression spring 26 is in operative communication with a free end 28 of the pin shaft 20 and the body 16 to provide vertical motion to the pin 18 upon application of a load or force, assuming, of course, that the pin 18 is not in a locked position. The spring constant of the compression springs 26 is optimized for the various workpieces to permit a desired amount of displacement. The head 22 is illustrated as having a generally convex surface and as will be described in greater detail below, is the point of contact between the clamp 10 and the workpiece 20 to be supported and clamped. Other shaped surfaces for the head are contemplated. In one embodiment, the diameter of the head is greater than the diameter of the sleeve.

The shaft 20 further includes an engageable portion 30 that is substantially aligned with a slidably mounted rod 32 of the lateral linear slide portion 14. The engageable portion 30 and the slidably mounted rod 32 provide a means for selectively locking the pin 18 against further vertical movement. The engageable portion 30 can comprise a threaded shaft portion aligned in operative communication with the slidably mounted rod 32 as shown, a serrated portion, an indentation, or like configurations that become lockingly engaged upon contact with rod 32. Optionally, the engageable portion 30 can extend along the entire length of the pin and in some embodiments, may be limited to only a surface of the pin that contacts the slidably mounted rod 32 upon engagement thereof.

As will be discussed in greater detail below with respect to the linear slide portion 14, the end of the slidably mounted rod 32 has a geometry complementary to the engageable portion 30 and is slidably positioned in a laterally extending opening 34 in the body to lockingly engage the engageable portion 30 upon contact therewith. In this manner, selective advancement of the rods 32 through the opening 34 results in contact with the engageable portion 30 between the rod and the shaft and thereby prevents vertical movement of the pins. In one embodiment, each pin 18 is preferably in operative communication with a single rod 32. In other embodiments, a single rod can be used to effectively engage numerous pins 18.

The pins 18 are fabricated from a suitable material having sufficient strength to sustain, without undergoing permanent deformation, the mass of the given workpiece 20 and the applied clamp load. Optionally, the pinheads 18 are formed or coated with a low durometer material such as a polymer. Suitable polymers include thermoplastic resins and thermoset resins. Non-limiting examples include polyurethanes, rubbers, and the like, among others. In one embodiment, a sheet of the low durometer material is draped or disposed over the pins. In this embodiment, the thickness of the sheet can be defined by the spacing between adjacent pinheads, wherein the thickness is slightly less than the spacing. In other embodiments, the pins are individually covered and/or coated with the low durometer material.

The linear slide portion 14 includes a movable base 36 in operative communication with a cam 38. The cam is coupled to a rotatable shaft 40. Rotation of the cam 38 causes the movable body 36 to move the slidably mounted rods 32 into and/or out of the laterally extending opening 34 in the body 16. Optionally, other means for retracting or advancing the rod can be employed such as, for example, a solenoid (not shown). Still further, it is contemplated that the slidably mounted rods 32 may be advanced from the retracted position to the advanced position (or vice versa) by an individual drive system or may be simultaneously engaged by the cam, as shown. The slidably mounted rods 32 slide generally transverse to the vertical motion of the pins 18.

The motion of the rods 32 is preferably constrained by using guide holes 44 within the movable base 36 and alignment pins 46 of a spacer member 48, which have sufficient tolerances to minimize lateral or vertical motion of the rods apart from the direction of the linear slide movement. The spacer member 48 is shown intermediate the movable base 36 and the body 16. In one embodiment, the rods 32 are isolated from one another by means of springs 42 as a load-transmitting element.

Optionally, stops 50 may be provided along the shaft of the pin to prevent unrestrained retraction or extension of the spring-loaded pins. The stop 50 may be in operative communication with shoulders formed in the shaft sleeve by means of a recess 52 in the body 16 about a portion of the pin 18, for example.

Optionally, the bodies 16 and 14 are gimbaled to permit a range of workpiece angular orientations relative to the fixture while still maintaining an approach direction approximately parallel to the direction of pin displacement. Although the body 14 is illustrated as generally having a polygonal shape, other shapes are contemplated.

In another embodiment, the portion of the rod 32 that contacts the engageable portion 30 is formed of a compliant material that will adopt such a complementary geometry when driven into engageable portion 30.

FIGS. 3-7 schematically illustrate a reconfigurable clamp system 60 at various stages of a process sequence employing the reconfigurable clamp 10. In FIG. 3, a workpiece 20, e.g., an automotive body panel, is shown being loaded in the direction indicated by arrows onto the reconfigurable clamp 10. A clamping member 62, e.g., a matching pressure foot, which pivots about pivot point 64 is in a retracted position to enable loading. The mass of the workpiece 20 compresses and displaces the spring-loaded pins such that all pins are in contact with the workpiece 20. Because the pins are spring-loaded, the pins collectively conform to the workpiece surface. Once stabilized, the cam is rotated to cause the slidably mounted rods to engage the pins via the engageable portions to prevent further movement of the pins within the sleeve.

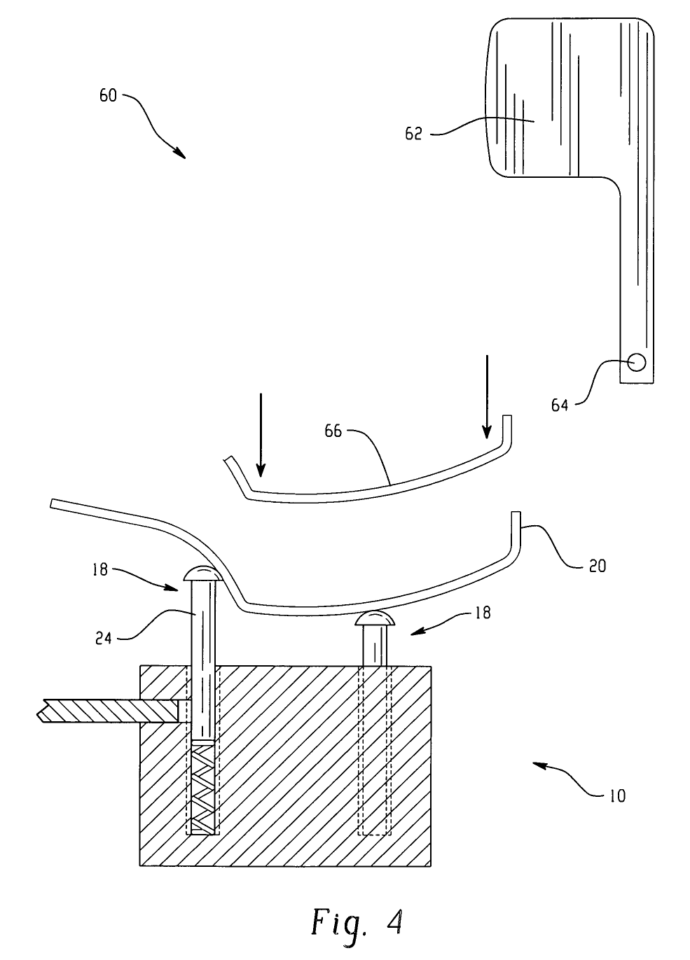

In FIG. 4, workpiece 20 is shown fully seated onto the clamp 10 causing the pins therein to compress against the compression springs such that the pins conform to the part geometry. Once the workpiece 20 is loaded, the pins are locked in place by advancement of the rods. The pressure foot 62 remains in the retracted position to enable loading of a second workpiece 66, e.g., a reinforcement panel or the like. By way of example, the second workpiece 66 can be designed to self-locate by closely conforming to the matching contours of workpiece 20.

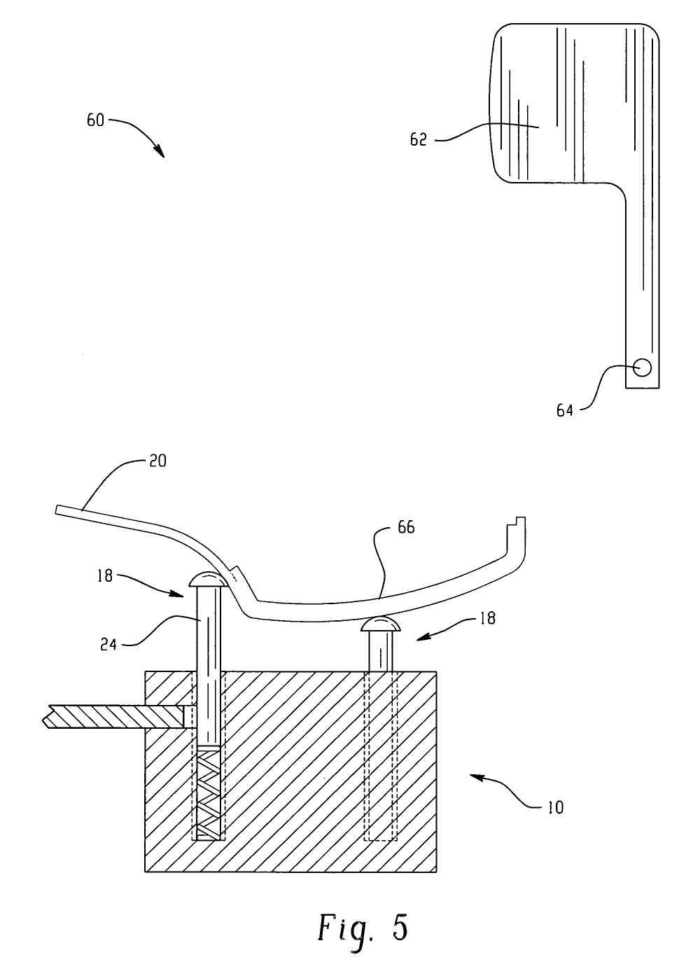

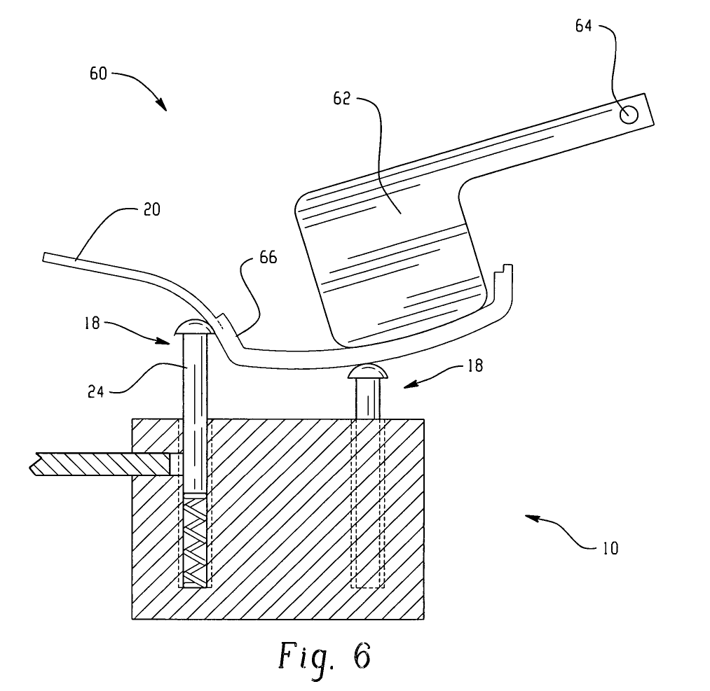

In FIG. 5, the second workpiece 66 is shown seated against workpiece 20. In FIG. 6, the clamping member 62 pivots about the pivot point 64 to clamp workpiece 20 and the second workpiece 66 against the reconfigurable clamp 10. In one embodiment, the clamping member 62 has a contact surface formed of a compliant material so as to deform upon contact with workpiece 20, thereby providing greater surface contact upon clamping.

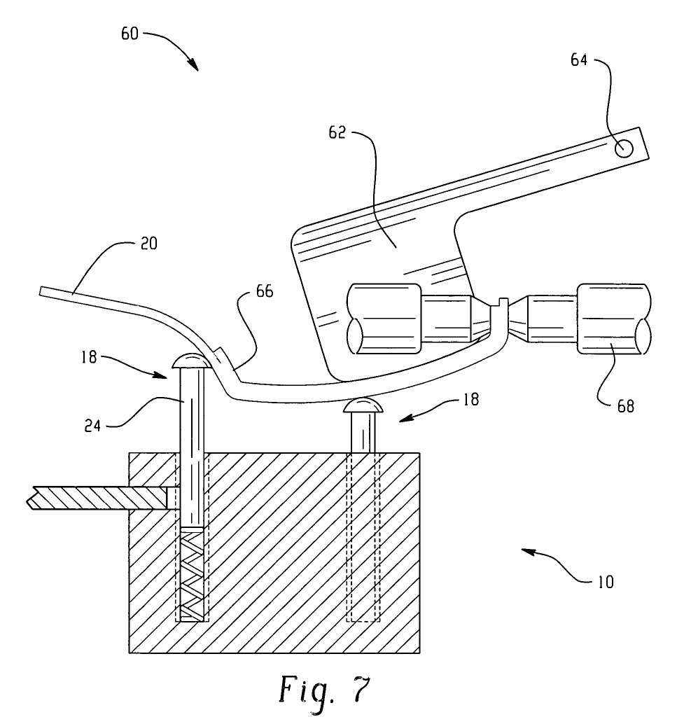

In FIG. 7, a pair of (resistance spot) welding electrode tips 68 attached to a welding gun (not shown) are moved into position to weld the second workpiece 66 to workpiece 20. For automotive body panel operations, the welds are preferably along a flange. The welding electrode tips 68 may be located along any part of the common flange length, where they do not interfere with the clamping member 62 and clamp 10. Although reference has been made to welding operations, other processing equipment can be employed as may be desired for different applications.

At the conclusion of the weld(s), the welding electrode tips 68 are removed and the clamping member 62 is pivoted to a retracted position. The assembled workpiece 20, 66 is then removed from the fixture and advanced to the next station, if desired.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A reconfigurable clamp, comprising:
a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body; and
a linear slide portion comprising a movable body and a rod extending from the movable body; wherein one end of the rod is slidably mounted in the opening and comprises a geometry complementary to the engageable portion.

2. The reconfigurable clamp of claim 1, wherein the body comprises a plurality of the pins spatially located therein, wherein each one of the plurality of pins is in sliding engagement one of a plurality of the sleeves and is in operable communication with a selected one of the rods.

3. The reconfigurable clamp of claim 1 further comprising a spacer member intermediate the movable body and the body, wherein the spacer is in operative communication with the rod.

4. The reconfigurable clamp of claim 1, further comprising a compression spring intermediate the movable portion and the rod.

5. The reconfigurable clamp of claim 1, wherein the movable body is in operative communication with a cam adapted to selectively move the movable body.

6. The reconfigurable clamp of claim 1, wherein the movable body is in operative communication with a solenoid adapted to selectively move the movable body.

7. The reconfigurable clamp of claim 1, wherein the body has at least one gimbaled surface.

8. The reconfigurable clamp of claim 1, wherein the head further comprises a polymeric coating disposed thereon.

9. The reconfigurable clamp of claim 1, wherein the head has a diameter greater than a shaft diameter.

10. The reconfigurable clamp of claim 1, wherein the sleeve is dimensioned to prevent lateral movement of the pin.

11. The reconfigurable clamp of claim 1, wherein the rod comprises a compliant material adapted to provide the complementary geometry upon contact with the engageable portion.

12. A reconfigurable clamp system, comprising:
a support comprising a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body, and a linear slide portion comprising a movable body, and a rod extending from the movable body, wherein one end of the rod is slidably mounted in the opening and comprises a geometry complementary to the engageable portion; and
a member in operative communication with the support.

13. The reconfigurable clamp system of claim 12, wherein the body comprises a plurality of pins spatially located therein, wherein each one of the plurality of pins is in sliding engagement with a selected one of a plurality of sleeves.

14. The reconfigurable clamp system of claim 12, wherein the engageable portion comprises a serrated portion or a threaded portion or a recessed portion.

15. The reconfigurable clamp system of claim 12, further comprising a spacer member intermediate the movable body and the body, wherein the spacer is in operative communication with the rod.

16. The reconfigurable clamp of claim 12, further comprising a compression spring intermediate the movable portion and the rod.

17. The reconfigurable clamp of claim 12, wherein the movable body is in operative communication with a cam or a solenoid adapted to selectively move the movable body.

18. The reconfigurable clamp of claim 12, wherein the rod comprises a compliant material adapted to provide the complementary geometry upon contact with the engageable portion.

19. A process for clamping a workpiece, the process comprising:
loading a first workpiece onto a reconfigurable clamp, wherein the reconfigurable clamp comprises a reconfigurable contact portion comprising a body, a sleeve disposed within the body, a pin disposed in sliding engagement with the sleeve, and an opening in transverse communication with the sleeve, wherein the pin comprises a head, a shaft comprising an engageable portion extending from the head, and a compression spring in operative communication with the shaft and the body, and a linear slide portion comprising a movable body, and a rod extending from the movable body, wherein one end of the rod is slidably mounted in the opening and comprises a geometry complementary to the engageable portion;
compressing the pin to conform substantially to a surface contour of the first workpiece;
moving the movable body in an amount and direction effective to advance the rod to lockingly engage the engageable portion; and
applying a member to a backside of the first workpiece.

20. The process of claim 19, further comprising removing the member;
moving the movable body in an amount and direction effective to retract the rod to locking disengage the engageable portion; and removing the first workpiece from the reconfigurable clamp.

21. The process of claim 19, further comprising loading a second workpiece onto the reconfigurable clamp, wherein the second workpiece has a different surface contour than the first workpiece; compressing the pin to conform substantially to a surface contour of the second workpiece; moving the movable body in the amount and direction effective to advance the rod to lockingly engage the engageable portion; and applying a member to a backside of the surface of the second workpiece.
